(19) United States
(12) Patent Application Publication
(10) Pub. No.: US 2014/0140083 A1
(43) Pub. Date: May 22, 2014

(54) LIGHTING DEVICE FOR A MOTOR VEHICLE

(71) Applicant: Automotive Lighting Reutlingen GmbH, Reutlingen (DE)

(72) Inventor: Hubert Zwick, Stuttgart (DE)

(21) Appl. No.: 14/082,554

(22) Filed: Nov. 18, 2013

(30) Foreign Application Priority Data
Nov. 22, 2012 (DE) 102012221385.6

(51) Int. Cl. F21S 8/10

(52) U.S. Cl. CPC F21S 48/17; F21S 48/1241
USPC 362/511

(57) ABSTRACT

A light for a motor vehicle is presented, with a light conductor which is designed to locally deflect the light propagating in it so that the deflected light emerges through the light emitting surface in a light beam that is centered around one preferential direction to generate a signal light distribution in accordance with the regulations, which subtends a predetermined angle region in a first spatial direction (z) and in a second spatial direction, and wherein the first spatial direction, the second spatial direction, and the preferential direction are each pairwise orthogonal to each other. The light is characterized in that it has a diaphragm that extends starting from the light conductor in a diaphragm direction lying between the preferential direction (x) and the first spatial direction and runs outside the aperture angle, and wherein the diaphragm extends starting from the light conductor for a length that corresponds to 2.5 to 6 times the thickness of the light conductor, especially 4.5 to 5.5 times, especially 5 times the thickness of the light conductor.

### CROSS-REFERENCE TO RELATED APPLICATION

This application is based upon and claims priority to published German Patent Application 10 2012 221 385.6, filed on Nov. 22, 2012.

### BACKGROUND OF INVENTION

1. Field of Invention

The invention concerns a light for a motor vehicle.

2. Description of the Related Art

The term “a light” refers to a lighting device that fulfills at least one automotive signal light function, such as daytime running lights, brake lights, and blinking lights. Signal light functions let other drivers know the presence of a vehicle and its present (e.g., braking) or future (e.g., making a turn) behavior. Such a light is known in the art and includes a light conductor which has a length, a thickness, a light emitting surface, and imaginary cross sections lying transversely to the light emitting surface and parallel to the thickness, where the length is greater than the thickness. The light conductor is designed to locally deflect the light propagating in it (which passes through the imaginary cross sections) upon its impinging on deflection surfaces arranged in a boundary surface of the light conductor, so that the deflected light emerges through the light emitting surface in a light beam that is centered around one preferential direction. Further, an aperture angle of the light beam is large enough to generate a signal light distribution that comports to government regulations, and which subtends a predetermined angle region in a first spatial direction and in a second spatial direction, and wherein the first spatial direction, the second spatial direction, and the preferential direction are each pairwise orthogonal to each other.

When the light is used as intended in a motor vehicle, the first spatial direction lies parallel to a vertical axis of the vehicle, and the second spatial direction lies parallel to a transverse axis of the vehicle. Moreover, the preferential direction lies parallel to the straight driving direction. If the light is a front light, the preferential direction points forward. If the light is a tail light, the preferential direction points backward. Such a lighting device has diverse uses in automotive lighting. For example, a headlight having a light of the mentioned kind is known from published German Application DE 10 2007 005 779 A1.

The use of light conductors in automotive lighting enables a spatial separation between the light generating point and the surface emitting the light. The use of light conductors allows designers to create three-dimensional light curves which simultaneously affect the visual appearance of the motor vehicle and produce a light distribution as mandated by law and thus compliant with government regulations. To achieve the desired light distribution, the light conductor must have special outcoupling elements inside or optically-active elements on or in front.

One drawback known in the art is that the light conductors often produce light distributions that are compliant with government regulations, but when viewed from certain angles (situated outside the compliant light distribution) have an unattractive visual appearance in the illuminated state. For example, they may appear to have an inhomogeneous glow and/or a so-called “pigtail effect” in which a luminous curve appears to wind around the light conductor body. This is perceived as being aesthetically undesirable. Furthermore, when the lighting device is in the off state, the outcoupling elements or other optically active elements of the otherwise clear-glass light conductor are visible as a dashed structure. This likewise negatively impacts the optical appearance of the motor vehicle in the non-illuminated state.

### SUMMARY OF THE INVENTION

The present invention is directed toward an automotive lighting device that is free from the disadvantages in the art discussed above. The present invention differs from the prior art mentioned above in that, to an observer viewing the lighting device on a motor vehicle from above a government-regulated height, the diaphragm projects so far beyond the light conductor that the light conductor is concealed by the diaphragm.

In one embodiment, the light has a diaphragm that extends starting from the light conductor in a diaphragm direction lying between the preferential direction and the first spatial direction and runs outside the aperture angle, and wherein the diaphragm extends starting from the light conductor for a length that corresponds to a ratio of 2.5 to 6 times the thickness of the light conductor. A ratio of 4.5 to 5.5 times is also desirable. A ratio of 5, in particular, is favorable.

The diaphragm conceals the light conductor when looking from positions situated on the side of the diaphragm facing the aperture angle, but lying outside the legally mandated aperture angle (e.g., +/−10° in the vertical direction, measured from the horizontal level). As a result, the light conductor is not visible from viewing angles that are concealed by the diaphragm. Because of the dimensions of the diaphragm of the present invention, the light conductor is not visible from viewing angles for which the described negative visual aesthetic effects may occur (without such a diaphragm).

Because the diaphragm extends from the light conductor in a diaphragm direction lying between the preferential direction and the first spatial direction and runs outside the aperture angle, no light is shielded that contributes to creating the government-regulated light distribution. In particular, because the diaphragm extends starting from the light conductor for a length that corresponds to a ratio of 2.5 to 6 times the thickness of the light conductor (a ratio of 4.5 to 5.5 times is also desirable and a ratio of 5, in particular, is favorable), the light conductor is concealed from sight when looking from positions that result when viewing the vehicle from a slight distance (such as 1 m to 4 m). Such positions occur, for example, during vehicle sales negotiations, when an unattractive visual appearance would be especially unwanted. These drawbacks are avoided with the solution of the present invention.

This diaphragm constitutes a first diaphragm section arranged above the light conductor when used as intended. As a result, the observer who is looking at the lighting device from above the government-regulated light distribution sees only the first diaphragm section, but not the light conductor. It is also preferable that the length of the second diaphragm section starting from the light conductor corresponds to a ratio of 2.5 to 6 times the thickness of the light conductor. A ratio of 4.5 to 5.5 times is also desirable. A ratio of 5, in particular, is favorable. The second diaphragm section can have the same length as the first diaphragm section, or a different length.

The second diaphragm section prevents an observer who is looking at the lighting device from above a government-regulated light distribution from perceiving a minor reflection of the light conductor on a surface underneath the light conductor. The light conductor extends essentially horizontally lengthwise in the vehicle headlight. Normally, the light housings, whether they be housings of single lights or housings of headlights with integrated lights, or cover frames (also known as bezels) that bound off the lights from the vehicle body, are made as highly reflective surfaces. As a result, the light conductor is mirrored by these surfaces. For an observer who is looking at the light or the cover frame from outside the government-regulated light distribution (generally from above) to not have unsightly views of the back or bottom side of the light conductor by reflections on these components; these reflections are concealed by the second diaphragm section.

In another embodiment, the first diaphragm section and the second diaphragm section are joined together by a connection element. The connection element is preferably designed as a recumbent U with the first diaphragm section being arranged on the upper leg. The second diaphragm section is arranged on the opposite, lower leg of the U-shaped connection piece. A V-shaped configuration or a rectangular-section configuration of the connection piece is also conceivable. The advantage of having the first diaphragm section and the second diaphragm section as a single piece is that the diaphragm sections can be economically fabricated as a punched and bent sheet metal part or as an injection molded plastic part.

In addition, it is proposed that the first diaphragm section and the second diaphragm section confine a vertical light distribution of the light conductor to at least +/−10° with respect to the horizontal beam direction. That is, the arrangement of the diaphragms is such that none of the light needed to form the government-regulated light distribution is shaded. This means that the first diaphragm section must be tilted by at least 10° upward in the beam direction and the second diaphragm section by at least 10° downward in the beam direction. In the case of light conductors that are arranged tilted from the horizontal in the headlight or that have a strong sweep, one must make sure that no useful light (the light needed to produce the government-regulated light distribution) is shuttered out over the entire lengthwise dimension of the light conductor.

In particular, a strong sweep (a deviation of the lengthwise dimension of the light conductor from a perpendicular to the vehicle's lengthwise axis in plan view) results in the light conductor emitting light into areas lying to the side of the vehicle. In order to also accomplish the government-regulated light intensities in these areas and not exceed the limit values, the first diaphragm section and the second diaphragm section have here an angle of inclination other than +/−10°.

It is also preferable that the first diaphragm section, the second diaphragm section, and the connection element be made from a heat resistant material. High temperatures often occur in the light due to waste heat and/or an installation near the engine. This is particularly true for front lights integrated in the front headlights. Compared to signal lights, an especially large amount of heat is released in connection with headlight functions, such as dimmed light and high beams.

Plastics such as polymethylmethacrylate (PMMA) or polycarbonate (PC) are often used as materials for light conductors. PMMA has less absorption of the incoming light than PC, but is less heat resistant. Because of the diaphragm of the present invention, the light conductor is protected against the heat effects from internal heat sources of the vehicle. With the light conductor installed between the first diaphragm and the second diaphragm and the diaphragms joined by the connection element, the light conductor is especially well protected against the effects of heat due to the resulting comprehensive shielding, such that PMMA can be used in place of PC. This increases the light output by up to 33% as compared to the use of PC. Thus, the invention contributes to boosting the efficiency of the lighting device.

In another embodiment, at least one surface facing the light conductor of the first diaphragm section and/or the second diaphragm section and/or the connection element is highly polished. In many instances, it is not possible for the light conductor alone to confine the light coupled out from the light conductor by means of the outcoupling elements to a government-regulated light distribution, so that the outcoupled light beam is needlessly (or even unacceptably) broad. The shielding out of such light results in losses of light. These losses are avoided by the configuration with highly polished surfaces of the first diaphragm and/or the second diaphragm and/or the connection piece, because light is reflected such that it helps to form the government-regulated light distribution. In this way, the light output is substantially boosted, which reduces the number of required and thus also lowers the costs.

In addition, it is proposed that the first diaphragm section and/or the second diaphragm section includes holding elements that are designed to mount and/or secure the light conductor. The holding elements are adapted to the shape of the light conductor, such that the light conductor is mounted with form fitting. Preferably, the light conductor is only mounted at one point. However, an extension of the holding elements over the entire diaphragm along the light conductor is also conceivable. The holding elements are suited to support the light conductor in the light. There is a firm connection between light and diaphragm layout, including the first diaphragm section, the second diaphragm section, and optionally the connection element. However, the reverse case is also conceivable, in that the light conductor is firmly joined to the light, and the holding elements serve to support the diaphragm layout in the light. In this case, a further connection between the light and the diaphragm layout is not needed.

One embodiment calls for elastic restoring forces produced by the connection element to fix the light conductor in the holding elements. In this case, the legs of the U-shaped or V-shaped connection element are bent apart. This creates stress in the connection element which, after the light conductor is installed, forces the legs back to their original position. If a distance between the legs in their starting position is chosen such that it is somewhat smaller than the cross section of the light conductor, a residual stress will remain and the elastic restoring forces will fix the light conductor in the holding elements.

One advantageous configuration of the invention consists in that a light distribution in the beam direction is determined by the shape of the first diaphragm and/or the second diaphragm and/or the arrangement of the first diaphragm and/or the second diaphragm relative to the light conductor. Normally, the light distribution in the beam direction is determined by the shape of the light conductor or by the type and arrangement of the outcoupling elements. According to the invention, the light distribution is influenced by the arrangement and shape of the diaphragms. Thus, designers have great freedom in the configuration of the diaphragm arrangement, while the shape of the light conductor can be optimized according to the laws of physics. Furthermore, it is then possible to handle a diversity of applications with a single standardized light conductor, as is practiced in the art of room lighting: there is a standardized light source (an incandescent bulb) which is combined with various lamp shades. Analogized to the present invention, the light conductor takes on the role of the incandescent bulb, and the diaphragm the role of the lamp shade. In this way, the development costs for new light conductor shapes are saved and the production of a standardized light conductor is substantially more economical, since large quantities can be made from a single mold.

It is especially helpful for the first diaphragm section and/or the second diaphragm section to be situated in areas where no light is coupled out from the light conductor, wherein the first diaphragm section and/or the second diaphragm section reflect light coupled out from other areas of the light conductor and thereby ensure a geometrical visibility of the lighting device. The geometrical visibility describes an angle region in which a light must be visible. The luminous flux may be slight, especially in the case of light conductors that are arranged inclined in the light or that have a strong sweep the situation may occur that the light conductor is not visible from certain viewing angles. Because of the shape and/or arrangement of the diaphragm according to the present invention, light coming from the light conductor in another location can be reflected by the diaphragm into this viewing angle. This ensures the geometrical visibility and fulfills the requirements of government regulations.

Just as the diaphragm arrangement of the present invention is able to increase lighting effectiveness (that is, the light output of a light having a light conductor), the diaphragm arrangement can also be used to conceal less attractive areas of the light conductor from being viewed from directions that contribute to making up the light distribution. In this case, the useful light is masked in order to ensure the overall aesthetic image of the lighting device.

Other objects, features and advantages of the present invention will be readily appreciated as the same becomes better understood after reading the subsequent description taken in connection with the accompanying drawings.

The aforementioned features and those yet to be explained can be used not only in the particular specified combinations, but also in other combinations or by themselves, without leaving the scope of the present invention.

### BRIEF DESCRIPTION OF THE DRAWINGS

There are shown:

FIG. 1 illustrates an arrangement of a light conductor and a light source;

FIG. 2 illustrates one embodiment of a light according to the invention, in cross section;

FIG. 3 is a schematic representation of a first embodiment of a lighting device according to the invention, in cross section;

FIG. 4 is a schematic representation of the lighting device of FIG. 3 with beam paths;

FIG. 5 is a schematic representation of a second embodiment of a lighting device according to the invention in cross section;

FIG. 6 is a schematic representation of the lighting device of FIG. 5 in a view from above;

FIG. 7 is a perspective representation of the lighting device of FIG. 5;

FIG. 8 is a schematic representation of an advantageous modification of the lighting device of the invention in cross section, and

FIG. 9 is a configuration with a plate-like light conductor.

### DETAILED DESCRIPTION OF THE EMBODIMENTS OF THE INVENTION

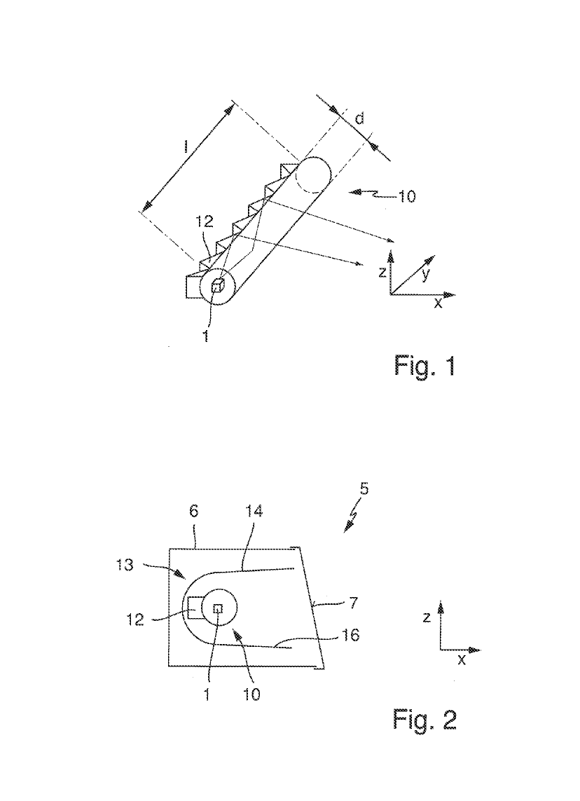

Referring now to the figures, where like numerals are used to designate like structure, FIG. 1 shows a perspective representation of an arrangement made up of a light conductor 10 and a light source 1. The light conductor 10 consists of transparent material, such as glass, PMMA (polymethylmethacrylate) or PC (polycarbonate). The light conductor 10 has an elongated cylindrical basic shape with outcoupling elements 12 formed on it. The light source is arranged at a narrow side of the light conductor so that the light emitted by it is coupled into the light conductor.

The light source is preferably a semiconductor light source or an arrangement of several semiconductor light sources, especially light emitting diodes. The light coupled in propagates along the cylindrical basic shape and undergoes total internal reflections at the cylindrical boundary surface of the light conductor, which serves as a transport surface. The outcoupling elements 12 here are implemented as prisms, which project outwardly from the light conductor material and are arranged in a row. The prisms could also be implemented as recesses in the light conductor material. In either case, boundary surfaces of the prisms constitute deflection surfaces.

The outcoupling elements are configured such that they reflect light in an angle that no longer satisfies the conditions for a total reflection the next time it impinges on the boundary of the light conductor, so that this light is coupled out from the light conductor material by refraction. FIG. 1 shows two beam paths 3, 4 for outcoupled light, the light being preferably coupled out so that a light distribution results that satisfies government regulations.

The x direction indicates the principal beam direction. The y direction and the z direction form with the x direction a right-handed system of coordinates. In the case of a daytime running light as the lighting device, the x direction corresponds to the driving direction. The z direction points upward. The directional specifications pertain to a use of the lighting device as intended in a vehicle.

A light distribution compliant with government regulations is characterized in that a predetermined angle region is illuminated with a predetermined intensity. In the case of a daytime running light distribution, an angle region of +/−20° must be illuminated in the horizontal and an angle region of +/−10° in the vertical. Furthermore, the light from an even larger angle region must still be visible, even though it need not illuminate this larger angle region so strongly. This angle region horizontally spans angles up to 45° in the direction of the center of the vehicle and 80° to the outside.

FIG. 1 shows a light conductor having a length l, a thickness d, a light emitting surface, and imaginary cross sections situated transversely to the light emitting surface and parallel to the thickness. The light emitting surface is part of the envelope surface of the light conductor lying opposite the outcoupling elements. The light from the light source 1 enters the light conductor through the imaginary cross sections and is locally deflected by impinging on deflection surfaces arranged in a boundary surface of the light conductor so that the deflected light emerges from the light conductor through the light emitting surface. The light conductor geometry is designed so that light is refracted such that the emitted light forms a light beam that is centered about a preferential direction. In the depicted embodiment, this is assisted by the curved shape of the light emitting surface. Furthermore, the angle at which the light rays arriving from inside the light conductor impinge on the light emitting surface also plays a role. The shape and arrangement of the deflection surfaces and the homogeneity of the light propagating in the light conductor also play a role, which also depends on the length and the thickness of the light conductor. The light conductor is configured such that an aperture angle of the light beam is large enough to generate a government regulation-compliant signal light distribution that spans a predetermined angle region in both a first spatial direction and a second spatial direction, and where the first spatial direction, the second spatial direction, and the preferential direction are each pairwise orthogonal to each other.

FIG. 2 shows a light 5 that has a housing 6, in which the light conductor 10 and the light source 1 are arranged. Furthermore, the light has a diaphragm 13, which has an upper diaphragm section 14 as the first diaphragm section and a lower diaphragm section 16 as the second diaphragm section.

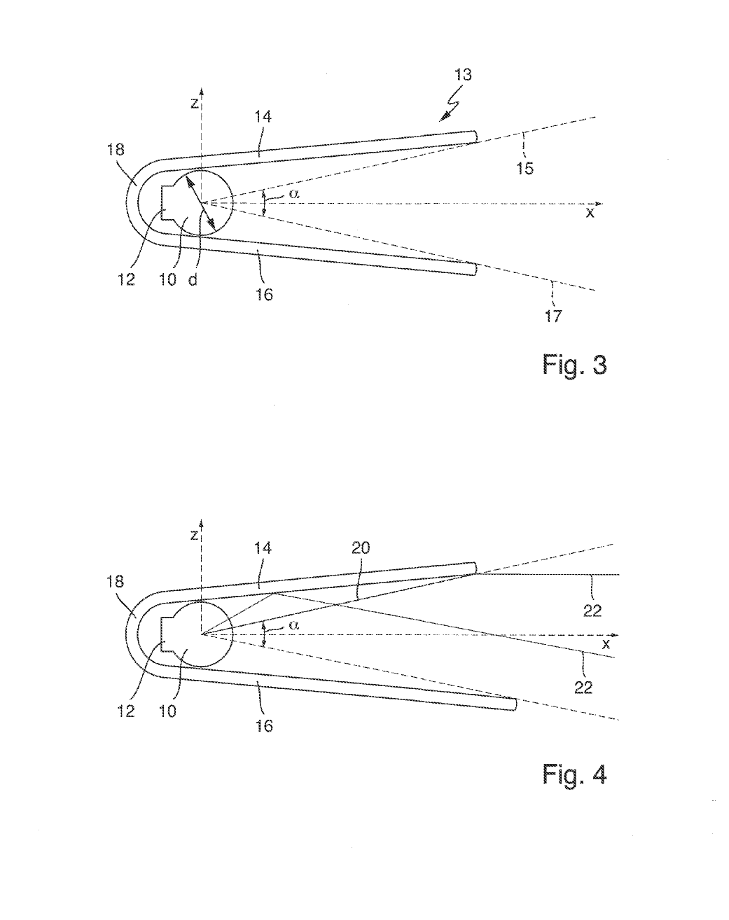

FIG. 3 shows an arrangement of the light conductor 10 and the diaphragm 13 in a cross section running parallel to a plane defined by the first spatial direction and the preferential direction. The z direction indicates the first spatial direction, and the x direction indicates the preferential direction. This also holds for the following FIGS. 4 to 8. The light conductor 10 extends in its length dimension 1 perpendicular to the plane of the drawing in FIG. 2.

The light conductor 10 in the first sample embodiment shown has a curved cross section, particularly in the area of the light emitting surface (i.e., the boundary surface that faces the preferential direction). Viewed from outside the light conductor, the cross section is preferably convex curved, because this contributes to a bundling of the light in the preferential direction. On a side of the light conductor opposite the light emitting surface, the prismatic outcoupling elements 12 are arranged along the light conductor 10, having deflection surfaces. The outcoupling elements 12 deflect light propagating in the light conductor 10 by total reflection, so that when the light again impinges on a boundary surface of the light conductor, the conditions for total reflection no longer exist and the light emerges by refraction from the light conductor 10 in the desired manner (i.e., in the direction of the positive x axis).

The diaphragm 13 has a first diaphragm section 14. This extends, starting from the light conductor, in a diaphragm direction lying between the preferential direction x and the first spatial direction z and thus runs outside the aperture angle, which is defined by the light distribution according to government regulations. The marginal rays 15 and 17 which delimit a cone in FIG. 3 thus each subtend an angle a with the preferential direction x that is larger than the aperture angle of the light beam needed to generate a light distribution compliant with regulations.

The first diaphragm section 14 and the second diaphragm section 16 are thus inclined to the preferential direction so that only light emitted at an angle a to the x axis is not shaded out by the first diaphragm 14 or the second diaphragm 16. The diaphragm projects beyond the light conductor far enough so that the light conductor is concealed by the diaphragm for an observer who is looking at the lighting device from above a government-regulated light distribution when the light is used as intended in a motor vehicle. Consequently, the light conductor is not visible from viewing angles that are concealed by the diaphragm.

The diaphragm sections 14 and 16 and thus also the diaphragm 13 extend starting from the light conductor for a length that corresponds to a ratio of 2.5 to 6 times the thickness of the light conductor. A ratio of 4.5 to 5.5 times is also desirable. A ratio of 5, in particular, is favorable. In the example shown, the length of the first (upper) diaphragm section 14 measured from the z direction is around 5 to 6 times the thickness d. The dimension of the second (lower) diaphragm section 16 is comparatively less important. In particular, it can be the same as the dimension of the first diaphragm section. In the example shown, it is slightly larger.

Because of the specified dimensions of the diaphragm, the light conductor is not visible from viewing angles at which the described negative appearance effects could occur without such a diaphragm (inhomogeneous lighting, pigtail effect, outcoupling elements, or other optically-active elements of the otherwise clear-glass light conductor recognizable as dashed structure in the turned-off state).

The first diaphragm section 14 and the second diaphragm section 16 are joined together by a U-shaped connection piece such that they form a single unit of continuous material.

The connection piece 18 is situated behind the light conductor 10 from a viewing direction looking into the light, so that the outcoupling elements 12 of the light conductor 10 point toward the connection piece 18. The light conductor 10 is, for the most part, enclosed by the first diaphragm section 14, the U-shaped piece 18, and the second diaphragm section 16. Only an angle segment of magnitude a is not concealed by the nontransparent diaphragm 13. The first diaphragm section 14 lies above the light conductor 10 when the light is used as intended and prevents an observer located in front of the light at a slight distance (such as 1 m to 3 m) outside the vertical light distribution (dictated by government regulations) from seeing the light conductor.

The second diaphragm section 16 lies beneath the light conductor 10 when used as intended and has the effect that the aforementioned observer also does not have views of the light conductor 10 from below or from behind, which would otherwise be possible by reflections on a mounting or a cover frame of the light or the headlight.

As described above, the government regulations require a vertical light distribution of not more than +/−10° starting from the horizontal. From the prior art it is possible in very few cases to limit the light emerging directly from the light conductor 10 solely by the refraction occurring upon its emergence in keeping with the legal regulations. As a result, considerable losses in light output occur, because a portion of the light emerging from the light conductor 10 has to be shaded and thus is lost to the illumination.

FIG. 4 shows an embodiment that eliminates this drawback. In particular, FIG. 4 shows the light conductor 10, the first diaphragm section 14, the second diaphragm section 16, and the connection piece 18 in a cross sectional view. The cross section occurs in parallel to both the beam direction and the first spatial direction. Two rays 20 are shown emerging from the light conductor 10 at an angle that is substantially larger than the government-regulated 10° (α is larger than)10°. The rays 20 impinge on the first diaphragm section 14 and are reflected by this to the horizontal. The result is reflected rays 22, which are beamed out in the angle range between −10° and +10° and thus contribute to the lighting. In this way, the light output is substantially boosted.

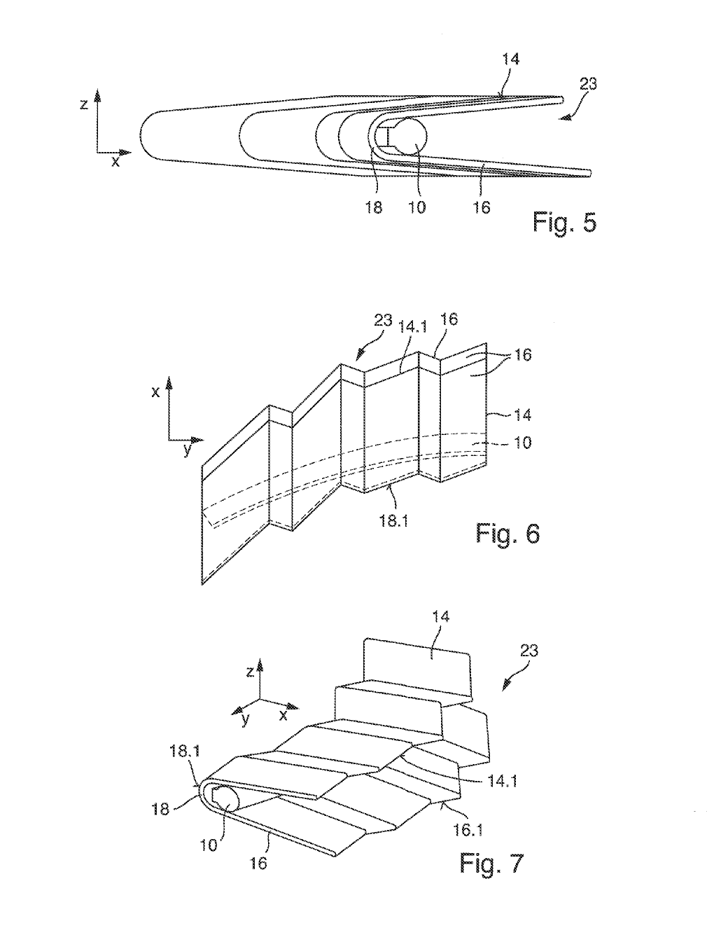

It is not necessary for the first diaphragm section 14 or the second diaphragm section 16 to extend uniformly and/or constantly over the entire length of the light conductor 10. Rather, it is possible for individual partial regions of the light conductor 10 to be masked individually by the upper diaphragm section 14 or the lower diaphragm section 16, or to appear visibly through reflections. FIGS. 5, 6, and 7 show different views of a less complex, flat diaphragm arrangement 23.

FIG. 5 shows the diaphragm arrangement 23 in a cross section. The plane of the cross section corresponds to the x-z plane. As shown in FIG. 5, the cross section of the diaphragm arrangement 23 (including the first diaphragm section 14, the second diaphragm section 16, =the connection piece 18, and the cross section of the light conductor 10) is the same as is shown in FIG. 3.

As is shown in FIG. 6, in the x-y plane, the light conductor 10 and the diaphragm arrangement 23 have a curved or swept shape and are bounded by the front edge 14.1 of the first diaphragm section 14, the front edge 16.1 of the second diaphragm section 16, and the end 18.1 of the connection piece 18.

FIG. 7 shows an isometric view of the diaphragm arrangement 23. The individual diaphragm sections 14, 16 are each flat in configuration. As is best demonstrated by observing one of the edges 14.1, 16.1, 18.1 as depicted in FIG. 7 in connection with FIG. 6. It is also possible to incline or curve the light conductor 10 in the z direction (i.e., in the first spatial direction), so long as no useful light is masked out along the entire length dimension of the light conductor 10; the government regulations with respect to the spatial light distribution need to be fulfilled.

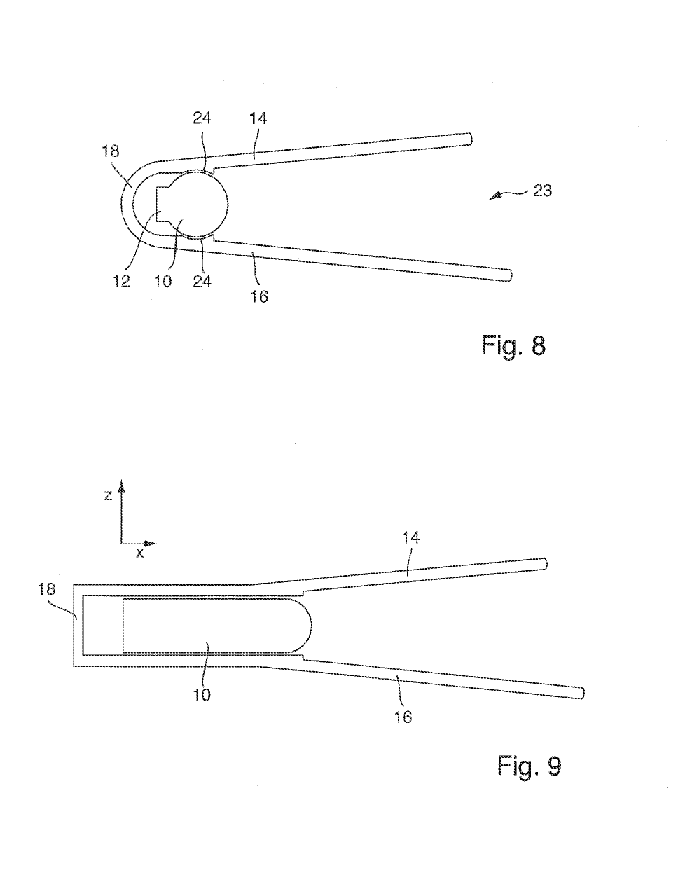

FIG. 8 shows another embodiment of the invention wherein the diaphragm arrangement 23 (comprising the first diaphragm section 14, the second diaphragm section 16, and the connection piece 18) is used as a fastening element for the light conductor.

FIG. 8 illustrates the cross section through the diaphragm arrangement 23 and the light conductor corresponding to FIG. 3. The diaphragms 14 and 16 differ from the diaphragms 14 and 16 shown in FIG. 3 in that they have shell-shaped holding elements 24. Thus, the light conductor 10 can be inserted between the upper first diaphragm section 14 and the lower second diaphragm section 16 in the holding elements 24. Preferably, the U-shaped or V-shaped connection piece 18 is configured so that the legs of the U or the V need to be spread apart somewhat in order to insert the light conductor 10 in the holding elements 24. In this way, elastic stresses are built up in the connection piece 18, ensuring that the legs of the connection piece 18 firmly embrace and hold the light conductor after it is inserted. For this purpose, the holding elements 24 are preferably configured so that the distance between the holding elements 24 that are coordinated with the first diaphragm section 14 and the holding elements 24 that are coordinated with the second diaphragm section 16, which is slightly smaller than the cross section of the light conductor 10. In this way, the legs of the connection piece 18 cannot fully return to their starting position after the light conductor 10 is inserted. Consequently, only a minor amount of stress remains in the connection piece 18 and the resulting elastic restoring forces secure the light conductor 10 in the holding elements 24.

FIG. 9 illustrates that the invention is not limited to rod-shaped light conductors and can also be implemented in connection with platelike light conductors. This essentially involves the dimensions of the light emitting surface in the z direction and the projection of the diaphragm in the x direction beyond the light emitting surface of the light conductor 10. Further, it should be noted that the length dimension of the light conductor 10 in a direction opposite the light emitting direction (which is substantially larger in the case of FIG. 9 than in the case of the other figures) has little impact.

Moreover, FIG. 9 shows a configuration in which the cross section of the diaphragm (lying in the plane of the drawing) has a shape that differs more from the shape of the light conductor than was previously discussed.

What is claimed is:

1. A light (5) for a motor vehicle, with a light conductor (10), which has a length, a thickness, a light emitting surface and imaginary cross sections lying transversely to the light emitting surface and parallel to the thickness, where the length is greater than the thickness and wherein the light conductor is designed to locally deflect the light propagating in it, which passes through the imaginary cross sections, upon its impinging on deflection surfaces arranged in a boundary surface of the light conductor, so that the deflected light emerges through the light emitting surface in a light beam that is centered around one preferential direction (x), while an aperture angle of the light beam is large enough to generate a signal light distribution in accordance with the regulations, which subtends a predetermined angle region in a first spatial direction (z) and in a second spatial direction, and wherein the first spatial direction, the second spatial direction, and the preferential direction are each pairwise orthogonal to each other, characterized in that the light has a diaphragm (13) that extends starting from the light conductor in a diaphragm direction lying between the preferential direction (x) and the first spatial direction (z) and runs outside the aperture angle, and in that the diaphragm projects so far beyond the light conductor that the light conductor (10) is concealed by the diaphragm (13) for an observer who is looking at the lighting device from above a legally mandated light distribution.

2. A light as set forth in claim 1, characterized in that the diaphragm extends starting from the light conductor for a length that corresponds to 2.5 to 6 times the thickness of the light conductor, especially 4.5 to 5.5 times, especially 5 times the thickness of the light conductor.

3. A light (5) as set forth in claim 1, characterized in that the diaphragm has a first diaphragm section (14) and a second diaphragm section (16), wherein the first diaphragm section extends starting from the light conductor in a diaphragm direction lying between the preferential direction and the first spatial direction, and wherein the second diaphragm section extends starting from the light conductor in a diaphragm direction lying between the preferential direction and a negative first spatial direction opposite the first spatial direction.

4. A light (5) as set forth in claim 3, characterized in that the first diaphragm section (14) and the second diaphragm section (16) are joined together by a connection element (18).

5. A light (5) as set forth in claim 3, characterized in that the first diaphragm section (14) and the second diaphragm section (16) confine a vertical light distribution of the light conductor (10) to at least +/−10° with respect to the horizontal beam direction (x).

6. A light (5) as set forth in claim 4, characterized in that the first diaphragm section (14), the second diaphragm section (16), and the connection element (18) are made from a heat resistant material.

7. A light (5) as set forth in claim 4, characterized in that at least one surface facing the light conductor (10) of the first diaphragm section (14), the second diaphragm section (16), or the connection element (18) is highly polished.

8. A light (5) as set forth in claim 4, characterized in that the first diaphragm section (14) and/or the second diaphragm section (16) has holding elements (24) that are designed to mount the light conductor (10).

9. A light (5) as set forth in claim 8, characterized in that elastic restoring forces produced by the connection element (18) fix the light conductor (10) in the holding elements (24).

10. A light (5) as set forth in claim 3, characterized in that a light distribution in the beam direction is determined by the shape of the first diaphragm (14) and/or the second diaphragm (16) and/or the arrangement of the first diaphragm (14) and/or the second diaphragm (16) relative to the light conductor (10).

11. A light (5) as set forth in claim 3, characterized in that the first diaphragm section (14) and/or the second diaphragm section (16) is situated in areas where no light is coupled out from the light conductor (10), wherein the first diaphragm section (14) and/or the second diaphragm section (16) reflect light coupled out in other areas of the light conductor (10) and thereby ensure a geometrical visibility of the lighting device
